(19) United States
(12) Patent Application Publication
(10) Pub. No.: US 2007/0281061 A1
(43) Pub. Date: Dec. 6, 2007

(54) FOOD DECONTAMINATION METHOD

(76) Inventor: Thomas Arthur Hinners, Las Vegas, NV (US)

Correspondence Address: WEISS & MOY PC, 4204 NORTH BROWN AVENUE, SCOTTSDALE, AZ, 85251, US

(21) Appl. No.: 11/422,374

(22) Filed: Jun. 6, 2006

(51) Int. Cl. A23L 1/00

(52) U.S. Cl. 426/437

(57) ABSTRACT

A food decontamination method is provided for removing contaminants from edible biological tissue such as fish. The method includes extracting the contaminant(s) from raw or cooked biological tissue with about 0.1N or greater acid solution and then neutralizing the acid solution. The contaminants removed include mercury and other inorganic contaminants, organic contaminants, and radioactive isotopes.

### FIELD OF THE INVENTION

This invention relates generally to food decontamination. More specifically, this invention relates to a method for acid extraction of contaminants from edible biological tissues.

### BACKGROUND OF THE INVENTION

Food safety is a paramount public concern. Food safety is about ensuring that food is safe to eat. Several incidences of food contamination and foodborne illnesses have eroded consumer confidence in the food chain. Some of these foodborne illnesses result in death, at a high cost to society. In addition, the role of foodborne microorganisms and chemicals (natural or anthropogenic) in chronic diseases, such as arthritis, diarrhea, and cancer, remains undetermined. Public officials are also concerned about terrorist threats to the food supply. For example, food may be contaminated with exogenously and endogenously deposited radioactive isotopes through accidental or intentional releases from nuclear reactors and nuclear weapons.

The safety of edible biological tissues, such as from fish and other animals, and botanical materials, consumed by humans or animals, is of particular concern because contaminants readily bind to such tissues, are difficult to remove therefrom (see, e.g., U.S. Pat. No. 5,440,031 describing the administration of organic pharmaceutical agents and European Patent 0796555 describing the physical separation of contaminated from uncontaminated portions of cereal), and may be particularly harmful.

The safety of fish products, among other edible biological tissues, is highly desired as there are great health benefits from eating such fish products. Since the early 1970's, seafood products have become increasingly popular in the American diet, and have been widely promoted through scientific reports and government guides that cite fish as low in fat, easily digestible, and a good source of protein, important minerals, omega-3 fatty acids, and vitamins. Fish can be an important part of a balanced diet.

The industry markets fish products in a variety of forms for human consumption: fresh, canned, cured and frozen. Fish products such as fish cakes and fish sticks can involve the use of shredded, flaked, minced or comminuted tissues. In addition to products for human consumption, about a third of the world's fish catch is used to produce high-quality animal feed and industrial products. Farmers have found fish protein to be an excellent additive to livestock feeds, and improvements in food technology have allowed fish to be more widely distributed.

Unfortunately, studies have indicated that fish consumers may be exposed to dangerous levels of mercury by eating moderate amounts of fish. This mercury exposure is especially dangerous to developing fetuses and children because it can damage their neurological systems. Because of this potential danger, women of childbearing age and children are advised to limit their intake of certain fish species (Borenstein, Seth. 2002. More U.S. Water than Ever Bear Warnings of Contaminated Fish. Tribune Business News. Jun. 15, 2002). Other segments of the population are also discouraged by these warnings from using fish of any type for personal consumption, for pets, or for plants.

Mercury is found throughout the environment in metallic and different organic and inorganic forms. It affects the brain, spinal cord, kidneys and liver, and can affect the ability to feel, see, taste and move (Williams, Juliet. 2001. Scientists Tracing Lake Superior Mercury Contamination to Fish. The Associated Press State & Local Wire. Feb. 15, 2001). Fish and other seafood products are the main source of mercury in the human diet. Studies have shown that mercury concentration in fish and shellfish is 1000 to 10000 times greater than in other foods. (United States Environmental Protection Agency 2001).

An organic form of mercury, methylmercury, is the most common form of organic mercury. Methylmercury is formed when atmospheric mercury mixes with bacteria in stagnant water (Williams, Juliet Scientists Tracing Lake Superior Mercury Contamination to Fish. The Associated Press State & Local Wire. Feb. 15, 2001). The methylmercury concentration biomagnifies up the food chain. Therefore, the larger predatory fish such as tilefish, tuna, pike, bass, shark and swordfish have higher concentrations of mercury contamination. It has been found that these species of fish can bioaccumulate methylmercury 1 to 10 million times the concentration found in the surrounding waters.

The United States Food and Drug Administration (FDA) has determined that the “action level” for removing fish from U.S. commercial markets is an average concentration for a batch (“lot”) of fish containing more than 1 ppm methylmercury. This FDA limit applies only to fish sold commercially in the United States because non-commercial fish in the United States are covered under the authority of the United States Environmental Protection Agency. The FDA has reported that the average total mercury level in Gulf of Mexico tilefish was 1.45 ppm (according to the National Marine Fisheries Service), and 2 million pounds of domestically caught tilefish were sold in the United States in 2000 according to Raines, Ben, 2001. Feds Allow Sale of Contaminated Fish. Newhouse News Service. Aug. 24, 2001. In the United States, 3 to 5 percent of the population routinely eat 100 grams of fish per day, corresponding to about 3000 grams per month. Among women of childbearing age, 3 percent routinely eat 100 grams of fish per day. Therefore, mercury-contaminated fish are a real public threat.

In most adult fish, 90 to 100 percent of the mercury is methylmercury and is found in fish muscle (fillets) bound to proteins. Consequently, skinning, trimming or cooking the fish does not significantly reduce the mercury concentration. Indeed, several sources warn consumers that methylmercury cannot be removed from fish prior to consumption. For example, the State of Maryland (U.S.) Department of the Environment's fish advisory website (2001) provided that: “Mercury exposure cannot be reduced during fish preparation or cooking, as it is directly bound to the edible flesh.” The State of South Carolina (U.S.) Department of Health and Environmental Control's website (2002) contains a similar warning, “Cleaning and cooking do not remove mercury from fish. This is because mercury is stored in the meat portion of fish.” Likewise, the State of New York (U.S.) Department of Health website reports that: “Methylmercury is found throughout the part of the fish that is eaten; therefore, cleaning and cooking methods which may reduce exposure to other contaminants are NOT effective for reducing exposure to mercury and that the only way to reduce mercury intake is to reduce the amount of contaminated fish you eat.”

There have been attempts to remove mercury from fish tissue with variable results. Aizpurua et al. (Intern. J. Food Sci. Technol. 32:333-337, 1997) claim “no significant reduction of mercury” from slices of blue shark using a 0.5% cysteine solution based on the methods of Yannai & Saltzman (J. Sci. Food Agric. 24: 157-160, 1973), Schab et al. (J. Sci. Food Agric. 29: 274-280, 1978) and Spinelli et al. (J. Agr. Food Chem.: 264-268, 1973). Others have also tried cysteine solutions: Suzuki (Bull. Tokai Reg. Fisheries Res. Lab: 67-72, 1974, Lipre (Tallinna Poliitehnilise Instituudi Toimetised 489:41-44, 1980), Ohta et al. (Memoirs of Faculty of Fisheries, Kagoshima University 31: 273-278, 1982) and Okazaki et al. (Bull. Tokai Reg. Fisheries Res. Lab 114: 125-132, 1984). Some of these reports did not involve sliced tissue (fillets or steaks) but only shredded, minced, or comminuted fish tissue where one would expect higher mercury removal than in fillets or steaks because of the cysteine solutions reaching more surface area. Extracting solutions containing cysteine have been used above pH 4.5 (i.e., below 0.000032N acidity) by Spinelli et al. (1973) and above pH 1.4 (i.e., below 0.040N acidity) by Ohta et al. (1982) while Schab et al. (1978) claim that for cysteine solutions, “it appears that there is no advantage to lowering the pH level below 0.5” (i.e., above 0.32N acidity). U.S. Pat. No. 3,928,637 also describes the use of cysteine or homocysteine to reduce mercury. This process requires that the fish be in slurry form and heating the slurry is required to remove the mercury. Cysteine is believed to only remove contaminants that bind to sulfhydryl-containing compounds in the tissue by providing competing sulfhydryl sites. Schab et al. (1978) tried stronger acidity with cysteine and claimed “no advantage” presumably because strongly protonating the sulfur in the sulfhydryl groups blocks their availability for Hg ions.

Russian patent 2,166,860 and Russian patent 2,167,541 to Kaliningrad State Technical University describe, respectively, the use of a 0.01% pectin solution and a 0.1% solution of ascorbic acid to reduce mercury concentration in fish tissue. For the latter, the effect is (according to the Russian patent abstract) “due to the reductive property of ascorbic acid”, not its acidic property. The dilute acidic solution (0.1%) used in 2,167,541 having a pH near 3 is too weak with an ionization constant of 6.8×10⁻⁵ to extract (by the acidic property) mercury from fish tissue.

Accordingly, there has been a need for a novel method for substantially removing contaminants from food to make the food safer for consumption. There is also a need for a novel method to improve the safety of edible biological tissues consumed by humans and other life forms. There is a need for a method of substantially removing mercury from fish and other seafood, while substantially maintaining the beneficial nutritional effects. There is still an additional need for a method of substantially removing mercury from fish fillets and steaks and more complete removal from flaked fish tissue. The present invention fulfills these needs and provides other related advantages.

### SUMMARY OF THE INVENTION

The present invention resides in an improved food decontamination method, generally comprising the steps of extracting one or more contaminants from edible biological tissue using an acid solution with a normality equal or greater than 0.1N and neutralizing the acid solution.

Other features and advantages of the present invention will become apparent from the following more detailed description, taken in conjunction with the accompanying graphs which illustrate, by way of example, the principles of the invention.

### DETAILED DESCRIPTION OF THE PREFERRED EMBODIMENT

The present invention is concerned with an improved food decontamination method, generally comprising the steps of extracting one or more contaminants from edible biological tissue using an acid solution with a normality equal or greater than 0.1N, removing a portion of the acid solution from the tissue, and neutralizing the residual acid retained by the tissue with a neutralizing agent. The method may further comprise the step of removing the acid solution, for example, by rinsing the edible biological tissue with water or the like. The method may be used, for example, to remove mercury from raw or cooked fish tissue and comprises the steps of:

Soaking the fish tissue in refrigerated hydrochloric acid for a time period depending upon the desired degree of mercury removal and the physical form of the tissue (e.g., 20 minutes for shredded tissue and >24 hours for thick slices as shown in the Tables and Graphs);

Decanting the refrigerated hydrochloric acid from the fish tissue;

Soaking the fish tissue in a sodium bicarbonate solution; and

Soaking the fish tissue in water.

“Contaminants” as used herein means inorganic elements (e.g. mercury, lead cadmium, calcium, copper, lead, magnesium, manganese, potassium, iron, nickel, sodium and zinc (for each of which examples of removal from tissues are described below), radioactive isotopes and organic compounds.

For those who appreciate the benefits of the Periodic Table of the Elements, acidic extraction can be expected for radioactive strontium-90 (because of its proximity to calcium in the Periodic Table of the Elements), for the toxic elements aluminum and beryllium (which are, respectively, near zinc and above magnesium in the Periodic Table of the Elements), for radioactive cesium-137 (below potassium in the Periodic Table), for radioactive cobalt-60 (because cobalt is between iron & nickel in the Periodic Table of the Elements), and for radioactive iridium-192 (which is below cobalt and near mercury). The radioactive elements listed above are those of most security concern.

“Edible biological tissue” as used herein includes consumable tissues, preparations or extracts thereof from any animal or plant used for food or therapy or other form of human, animal or plant consumption. For example, “animal” includes but is not limited to terrestrial forms of mammals, reptiles, amphibians, fowls, insects, and microbes such as bacteria. Also, “fish” includes but is not limited to salt-, fresh- or brackish-water forms of fish. Additionally, “plant” includes but is not limited to any botanical or other crop product such as herbs, grain, flowers, fruits, seeds, leaves, stalks, bark or other plant fiber or plant extract. Furthermore, “tissue” includes any biological product such as fiber, flesh, bone, organ, or preparation or extract thereof.

Reagent grade HCl available from, for example, VWR International, Bristol, Conn., may be used with a normality greater or equal to 0.1N for mercury removal. For mercury removal, 2N HCl acid solution is preferred. It is to be appreciated that other strong acids (inorganic or organic) such as (but not limited to) hydrobromic, hydroiodic, and halogenated organic acids, such as mono-, di-, or tri-chlorinated acetic acid, at a normality equal to or greater than 0.1N (or pH<1) may be used. “Strong acids” are those that are extensively ionized in aqueous solutions.

For contaminants not bound to tissues as firmly as mercury (such as, but not limited to, calcium, cadmium, copper, lead, magnesium, manganese, potassium, iron, nickel, sodium and zinc) lower concentrations of strong acids, dilute oxidizing acids (such as, but not limited to, 0.16N nitric), or weak acids (such as acetic, citric) may be used at a normality equal to or greater than 0.1N.

The use of 0.16N nitric acid for 24 hours at ambient temperature (23° C.) removed 99% of calcium, 97% of copper, 100% of cadmium, magnesium, manganese, potassium, sodium, zinc, and 40% of iron from bovine liver. The use of 0.16N nitric acid for 21 hours at ambient temperature (23° C.) removed 89% of lead and 52% of nickel from other animal tissue.

The neutralizing solution may be a sodium bicarbonate solution made by dissolving approximately 5 grams of USP Baking Soda (available at grocery stores, or from chemical suppliers) in 130 grams of refrigerated potable water (or larger quantities in a similar proportion). This portion of sodium bicarbonate to water is not critical because the purpose is to neutralize any acid retained by the tissue, as judged by pH testing of the neutralizing solution after bubbling of carbon dioxide from the tissue ceases. Sufficient volume of the neutralizing solution should be used with the tissue until the solution retains a pH between 4 and 8, preferably 6.

### WORKING EXAMPLES

1) Shredded (flaked) tissue from shark and swordfish steaks were extracted with 2N hydrochloric acid (HCl) at a liquid-to-solid ratio of 20 at ambient temperature (about 23° C.) for the times indicated in Table 1.

2) Shark muscle was soaked in a refrigerated solution of 2N hydrochloric acid (HCl). After 20 hours in the refrigerator, the solution was decanted from the shark muscle. The shark muscle was then soaked in the refrigerated, food-grade (USP) baking soda (sodium bicarbonate) solution for 0.5 hour (to both rinse out the mercury-containing acid solution and to neutralize any residual acid in the tissue). The fish tissue should be substantially immersed in the baking soda solution. The shark muscle was then soaked in refrigerated de-ionized water for 0.5 hour (to rinse out the baking soda solution), and the water decanted from the shark muscle.

Initial and final mercury concentrations in the fish were determined by measuring the concentrations in the extract and in the extracted tissue using EPA Method 7473, incorporated herein by reference. The results are summarized below where Table 1 shows examples of shredded or flaked fish and Table 2 shows examples of non-shredded fish results:

TABLE 1
Shredded (Flaked) Fish

| | | Extraction | | % Mercury |
|---|---|---|---|---|
| Fish | Acid Solution | Duration | | removed |
| Swordfish | 2N HCl | 20 | minutes | 69.6 |
| Swordfish | 2N HCl | 20 | hours | 97.1 |
| Swordfish | 0.1N HCl | 4.6 | hours | 32 |
| Swordfish | 0.1N HCl | 16 | hours | 45 |
| Shark, | 2N HCl | 27 | minutes | 70.6 |
| Thresher | | | | |
| Shark, | 2N HCl | 20 | hours | 97.7 |
| Thresher | | | | |

TABLE 2
Non-Shredded (sliced) Shark Muscle (Single Extraction)

| Thickness of slice | Acid Solution | Duration | % Mercury removed |
|---|---|---|---|
| 20 mm | 2N HCl | 20 hours | 50 |
| 18 mm | 0.1N HCl | 24 hours | 4.4 |
| 18 mm | 1N HCl | 24 hours | 6.1 |

Use of potassium chloride (1.2% w/v) with the HCl serves to minimize swelling of the fish tissue and was prepared by dissolving 5.75 g of potassium chloride in 500 ml of the desired concentration of HCl acid. A liquid-solid ratio of 5 (v/w) is preferred. Using a 4N HCl solution containing 1.2% KCl with 25-mm thick shark tissue at 8° C. did not accelerate the removal of mercury in comparison to the use of 2N HCl as shown below in Graphs 1 and 2 shown below.

In particular, Graphs 1 and 2 illustrate the extraction of mercury from shark steak as a function of time, and show several measurement points during a first extraction and during a re-extraction, respectively, when microliter portions of the extracting solution were removed (after mixing the solution with a clean glass rod for at least 5 seconds), with liquid-to-tissue ratios (volume/mass) of 4.68 and 4.80 for 1^{st} and 2^{nd} extractions, respectively. At the times indicated, a microliter volume was removed for the determination of mercury, which is a trivial change to the total extract volume.

For thick slices, re-extraction may improve mercury removal as shown in Graphs 1 and 2. A milder extraction may precede a second extracting solution. As one example only, a first extraction using a 0.1N acid solution for 30 minutes or more, decanting and saving the solution before extracting the tissue again with a 2N strong acid solution. The easily extracted nutrients, which may be eluted during the mild extraction may be combined with the treated fish tissue to further realize the health benefits of the final product.

Although spoilage of the raw fish tissue was not noticeable with ambient-temperature extractions (Table 1), a preferred precaution against spoilage may be to conduct the extraction and neutralization steps with refrigerated (8° C.) solutions.

Although an extracting solution having a temperature of about 8 degrees Celcius has been described (Table 2), it is to be appreciated that other solution temperatures even below freezing (for part of the extraction time) and at boiling could be applied, pressures above atmospheric could force liquid through the tissue (to accelerate the extraction), and some extraction is achievable for acidities from at least 0.1N.

When the method has been completed, the edible biological tissue is substantially indistinguishable in appearance and flavor from the nontreated edible biological tissue.

From the foregoing, it is to be appreciated that an acidic solution may be used as a decontamination treatment to leach mercury, and other contaminants, in raw biological tissue (such as fish muscle) into the solution and leave the undissolved tissue lower in contaminant concentrations and, thereby, safer as a food. The method is most effective with shredded, flaked, comminuted, minced, or shaved (lox, sushi) fish tissue. While not wishing to be bound to any particular theory, chemically, hydronium ions in the acidic solution are believed to displace mercury, and other contaminants, bound to sulfur, or other moieties, in the tissue.

Although a particular embodiment of the invention has been described in detail for purposes of illustration, various modifications may be made without departing from the spirit and scope of the invention. Accordingly, the invention is not to be limited, except as by the appended claims.

I claim:

1. A method of substantially removing one or more contaminants from edible biological tissue, comprising the steps of:
extracting the one or more contaminants from the edible biological tissue with an acid solution having a normality equal to or greater than about 0.1N;
removing a portion of the acid solution from the edible biological tissue;
neutralizing the residual acid solution retained by the tissue with a neutralizing agent; and
rinsing the neutralizing agent out of the edible biological tissue.

2. The method of claim 1, wherein the neutralizing agent comprises sodium bicarbonate in water used in sufficient volume until the neutralized acid solution has a pH between about 4 and 8.

3. The method of claim 1, wherein the acid solution comprises a strong acid solution.

4. The method of claim 3, wherein the strong acid solution comprises about a 2N HCl acid solution and the one or more contaminants comprises mercury.

5. The method of claim 3, wherein the strong acid solution comprises at least one of a hydrochloric, hydrobromic, hydroiodic acid, and halogenated organic acid solutions.

6. The method of claim 5, wherein the strong acid solution extracts mercury.

7. The method of claim 1, wherein the acid solution is selected from the group consisting of strong acids, dilute oxidizing acids and weak acids and the one or more contaminants comprise at least one of aluminum, beryllium, calcium, cadmium, copper, lead, magnesium, manganese, potassium, iron, nickel, sodium and zinc.

8. The method of claim 1, wherein the edible biological tissue comprises at least one of terrestrial forms of mammal, reptile, amphibian, fowl, insect, plant, and microbe, and salt water and freshwater forms of fish and shellfish, and any botanical or crop product, and edible biological tissue comprises at least one of flesh, bone, organ, fiber, or component, preparation or extract thereof.

9. The method of claim 7, wherein the strong acids are selected from the group consisting of hydrochloric, hydrobromic, hydroiodic acid, and halogenated organic acids, the dilute oxidizing acids comprise a nitric acid solution, and the weak acids are selected from the group consisting of acetic and citric acid.

10. The method of claim 1, wherein the one or more contaminants are selected from the group consisting of inorganic contaminants, organic contaminants, and radioactive isotopes.

11. The method of claim 10, wherein the inorganic contaminants comprise one of mercury, lead, cadmium, calcium, copper, magnesium, manganese, potassium, iron, nickel, sodium and zinc or a combination thereof.

12. The method of claim 10, wherein the radioactive isotopes are selected from the group consisting of radioactive strontium-90, radioactive cobalt-60, radioactive cesium-137, and radioactive iridium-192.

13. A method of removing mercury from fish tissue, comprising the steps of:
extracting mercury from the fish tissue with a strong acid solution having a normality equal to or greater than about 0.1N;
removing a portion of the acid solution from the tissue;
neutralizing the residual strong acid solution retained by the tissue with a neutralizing solution; and
rinsing the neutralizing agent out of the tissue.

14. The method of claim 13, wherein the neutralizing agent comprises sodium bicarbonate in water used in sufficient volume until the neutralized acid solution retains a pH between about 4 and 8.

15. The method of claim 13, wherein the strong acid solution comprises hydrochloric, hydrobromic, hydroiodic acid, and halogenated organic acid solutions.

16. The method of claim 15, wherein the strong acid solution comprises about a 2N HCl acid solution.

17. The method of claim 13, further comprising the step of soaking the fish tissue in about a 0.1N or weaker acid solution prior to the step of extracting mercury from the fish tissue with a stronger acid solution.

18. A method of substantially removing mercury from fish tissue comprising the steps of:
soaking the fish tissue in about a 0.1N or greater hydrochloric acid solution;
decanting the hydrochloric acid solution from the fish tissue;
soaking the fish tissue in a sodium bicarbonate solution; and
soaking the fish tissue in water.

19. The method of claim 18, wherein the fish tissue is soaked in about a 2N or greater hydrochloric acid solution.
